(19) United States
(12) Patent Application Publication
(10) Pub. No.: US 2010/0173593 A1
(43) Pub. Date: Jul. 8, 2010

(54) MULTIBAND MICROWAVE TERMINAL

(75) Inventor: Francois Magne, Paris (FR)

Correspondence Address: LOWE HAUPTMAN HAM & BERNER, LLP, 1700 DIAGONAL ROAD, SUITE 300, ALEXANDRIA, VA, 22314, US

(73) Assignee: THALES, Neuilly Sur Seine (FR)

(21) Appl. No.: 11/721,943

(22) PCT Filed: Dec. 13, 2005
(86) PCT No.: PCT/EP05/56762

§ 371 Date: Dec. 7, 2009

(30) Foreign Application Priority Data
Dec. 15, 2004 (FR) 0413339

(51) Int. Cl. H04B 1/40

(52) U.S. Cl. 455/77

(57) ABSTRACT

A multiband microwave transceiver device, MMT, is disclosed. The device includes a circuit for coupling with an antenna, A₁, operating in a frequency range G₁ corresponding to multimedia services, to rich media services (synchronized image and Internet). A circuit can couple with an antenna, A₂, suitable for operating in a frequency range G₂ corresponding to Internet and voice services. A circuit can couple with an antenna, A₃, suitable for operating in a range G₃ and allowing direct operation with a commercially-available WIMAX modem in this band via the BIS frequency. Frequency synthesizers are provided which are suitable for the conversions and amplification and conversion circuits in both directions: Down-conversion from 40 GHz to the BIS frequency; Down-conversion from 10 GHz to the 3.5 GHz; and Up-conversion from 3.5 GHz to the 10 GHz.

### CROSS-REFERENCE TO RELATED APPLICATIONS

The present Application is based on International Application No. PCT/EP2005/056762, filed on Dec. 13, 2005, which in turns corresponds to French Application No. 0413339 filed on Dec. 15, 2004, and priority is hereby claimed under 35 USC §119 based on these applications. Each of these applications are hereby incorporated by reference in their entirety into the present application.

### FIELD OF THE INVENTION

The invention relates to a multiband microwave terminal suitable in particular for operating in a frequency range G₁ corresponding to multimedia services, a frequency range G₂ corresponding to Internet and voice services, and a frequency range G₃ corresponding to wireless access.

### BACKGROUND OF THE INVENTION

All the services of the NET and the information and communication technologies for all have become the major issue for local authorities. The operators need to offer more quality services. Their offers currently comprise multimedia, the Internet and telephone combined, an offer normally referred to as “Triple Play”. This offer is made possible through network technology in the celebrated “convergence” of multimedia, communications and information technology.

A regional or French departmental network normally comprises a transport or backbone network, in fiber optics (given the bit rates to be supplied to some 100 000 homes) and access networks to the subscribers or groups of subscribers. From the backbones, each subscriber or group of subscribers has to be connected.

For the performance levels envisaged in an area of average or sparse population density, ADSL cannot ultimately be the answer, because of the lengths of the wires which limit the instantaneous bit rate.

Satellite solutions have the drawback of not providing sufficient capacity.

It therefore seems that wireless solutions are preferable on condition that they provide: adequate bit rates to the subscriber, in particular for multimedia, and local capacity, that is, the total bandwidth for each to be able to exchange his own Internet contents. Such bit rates can be obtained by wireless only at high frequencies, in the Ku and W bands corresponding to wavelengths of a few centimeters or a few millimeters.

FIG. 1 shows the organization of the 40 GHz and 10 GHz channels.

### SUMMARY OF THE INVENTION

The subject of the invention is a multiband microwave terminal, having
a circuit for coupling with an antenna A₁, operating in a frequency range G₁ corresponding to multimedia services, to rich media services (synchronized image and Internet),
a circuit can couples with an antenna A₂, suitable for operating in a frequency range G₂ corresponding to Internet and voice services.
A circuit can couples with an antenna A₃, suitable for operating in a range G₃ and allowing direct operation with a commercially-available WIMAX modem in this band via the BIS frequency.
Frequency synthesizers are provided which are suitable for the conversions and amplification conversion circuits in both directions:
   Down-conversion from 40 GHz to the BIS frequency,
   Down-conversion from 10 GHz to 3.5 GHz,
   Up-conversion from 3.5 GHz to 10 GHz.

The invention also relates to a multiband microwave transceiver device comprising three antennas A₁, A₂ and A₃ and a wireless card.
A circuit can couples with the antenna A₁, operating in a frequency range G₁ corresponding to multimedia services, to rich media services (synchronized image and Internet),
A circuit can couples with the antenna A₂, suitable for operating in a frequency range G₂ corresponding to Internet and voice services.
A circuit can couples with the antenna A₃, suitable for operating in a range G₃ and allowing direct operation with a commercially-available WIMAX modem in this band via the BIS frequency,
Frequency synthesizers suitable are provided which are for the conversions and amplification conversion circuits in both directions:
   Down-conversion from 40 GHz to the BIS frequency,
   Down-conversion from 10 GHz to 3.5 GHz,
   Up-conversion from 3.5 GHz to 10 GHz.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, a diagram describing the organization of the 40 GHz and 10 GHz channels,

FIG. 2, a functional diagram of the inventive terminal,

FIG. 3, a block diagram of a multiband microwave terminal MMT according to the invention,

FIG. 4, the multiplex organization on the output of the MMT to the subscribers coaxial cable,

FIG. 5, an exemplary architecture of the inventive microwave terminal,

FIG. 6, the detail of the SiGe component of FIG. 5.

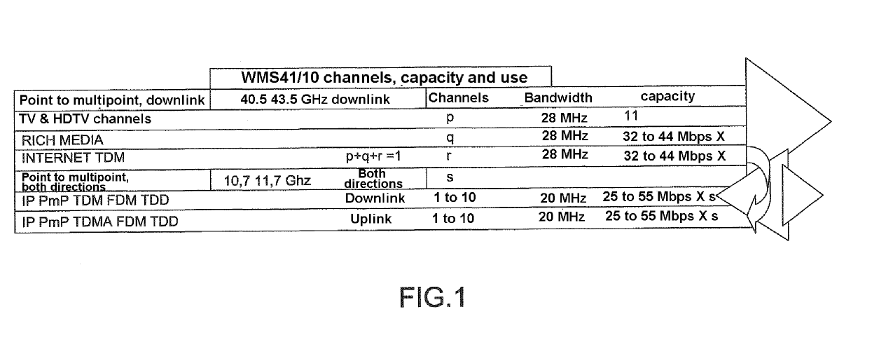

### DETAILED DESCRIPTION OF THE PREFERRED EMBODIMENT

In order to better understand the principle implemented in the invention, the example given by way of nonlimiting example relates to a microwave terminal, or MMT, used, for example, in a high-performance wireless multimedia access service intended for triple play. The system typically delivers television, TV, high-definition television, HDTV, video on demand, VoD, fast Internet, and so on. The frequency ranges involved are, in this exemplary implementation, the range G₁ corresponding to the band [40.5-43.5 GHz], the range G₂ or frequency band [10.7-11.7 GHz] and the range G₃ [3.4-3.5 GHz].

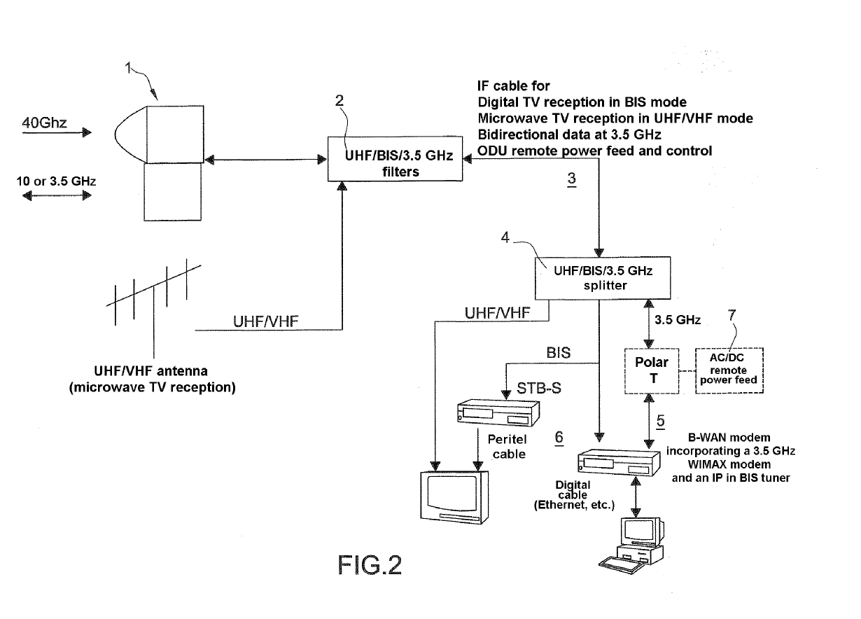

FIG. 2 shows the various functions that are possible for an MMT terminal according to the invention.

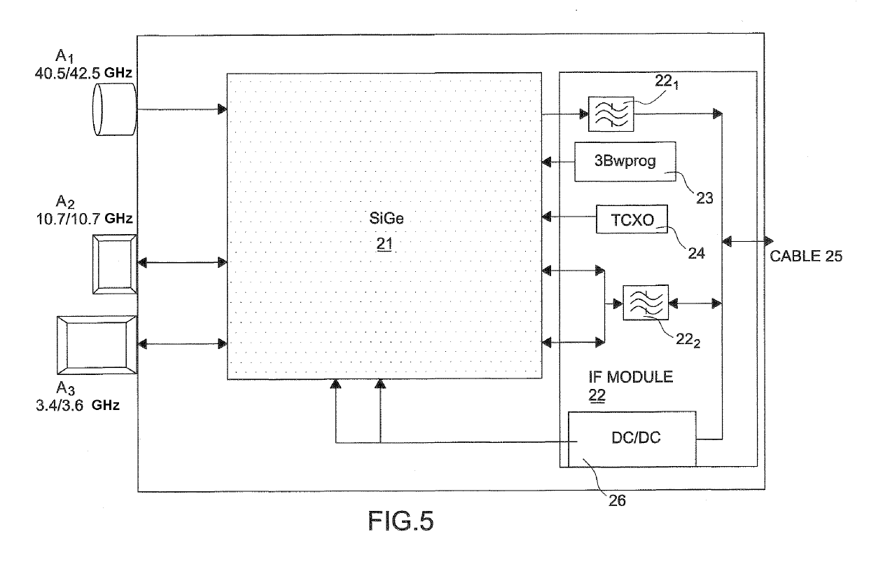

The multiband microwave terminal MMT, 1, handles, in the subscribers home, the reception and transmission of the multiband signals defined in FIG. 4 in order to serve a variety of appliances such as: television, digital cable, etc. This terminal is, for example, installed on a standard television aerial using a collar.

The MMT is interfaced, for example, as follows:
with the ether and from the network access base station, the MMT is interfaced by lens and/or patch antennas, or even multiband cassegrain antennas,
with the home appliances, the MMT is interfaced with the so-called Bis coaxial cable for a satellite intermediate band.

The subscriber's products served by the MMT are, for example:
multiple UHF/BIS/3.5 GHz filters, 2, linked by means of an IF cable 3 suitable for receiving digital TV in BIS mode, receiving microwave TV in UHF/VHF mode, bidirectional data at 3.5 GHz and for the remote power feed and control of the MMT,
a UHF/BIS/3.5 GHz (Ultra High Frequency) splitter 4,
a WimaX (Worldwide interoperability for Microwave) modem 5 and a digital television demodulator DVB with software to handle the bi-directionality of the IP (Internet protocol),
one or more set-top boxes 6 used for television and VoD,
AC/DC power supply 7 if necessary.

The MMT comprises several functions for amplifying the channels to the cable and vice-versa. FIG. 4 represents the multiplex organization on the MMT output to the subscriber's coaxial cable.

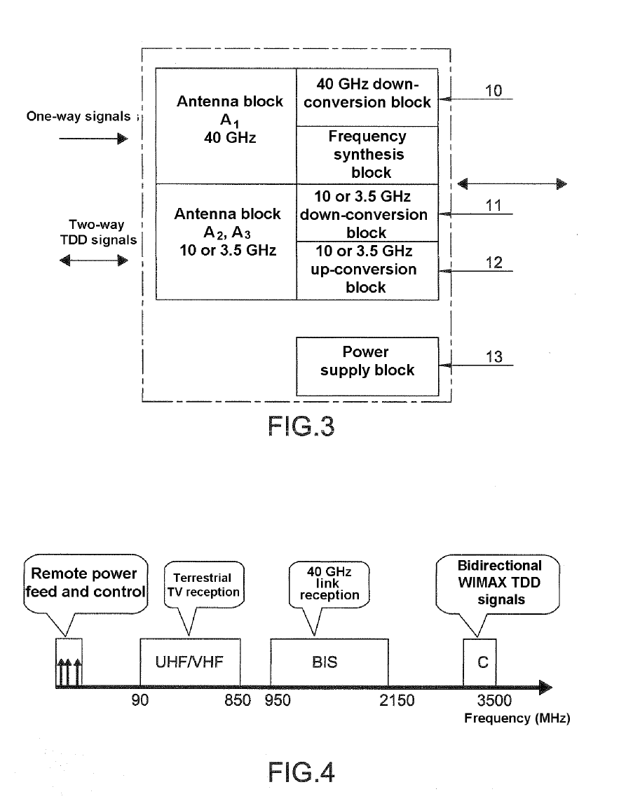

FIG. 3 shows the various functional blocks of an MMT terminal:
One or more 40 GHz antennas A₁,
One or more 10 or 3.5 GHz antennas A₂, A₃,
Frequency synthesizers suitable for the various frequency band conversions in both directions, and amplification conversion circuits. The conversions are, for example, as follows:
   Down-conversion from 40 GHz to the BIS frequency, referenced 10,
   Down-conversion from 10 GHz to 3.5 GHz, referenced 11,
   Up-conversion from 3.5 GHz to 10 GHz, referenced 12,
The power supply 13, the power for which comes from the subscribers set-top box or a power supply for collective, multiple subscribers, for example in the case of an apartment building.
   For transmission/reception at 3.5 GHz, the input/output is direct.

In the description, in the interests of simplicity, the circuits for coupling to the antennas are diagrammatically represented by lines in the figures. The coupling circuits are, for example, suited to the antennas A₁, A₂, A₃ that can be of lens, patch or Cassegrain type.

FIG. 4 represents the organization of the frequency bands of the MMT to the cable. The output multiplexing represents the result of the intermediate frequency circuits. The incoming channelization of the system has a corresponding outgoing channelization from the subscriber over his cable.

FIG. 5 is an exemplary physical architecture of the MMT.

This wireless comprises, for example, two subassemblies:

The circuits for coupling, not shown in the figure in the interests of simplicity, to the antennas A₁, A₂ or A₃, lens or patch antennas in the three frequency bands G₁, G₂ or G₃.

The wireless card which comprises, for example, the lines for matching to the antennas (hyperfrequency “line” passive circuits), the SiGe chip, 21, executing the reception and transmission, frequency transposition and synthesis functions, and finally, an intermediate frequency IF module, 22, handling the functions of filtering (22₁, 22₂) and adaptation to the cable 25 according to FIG. 4, the programming (3Bwprog) 23 of the bands that will be in operation, the DC/DC power supply 26.

The module 22 consists of circuits designed to control frequencies and circuits designed to adapt the signals to the BIS frequency.

The MMT in operation uses, for example, the Q band (G₁) and one or other of the Ku or C bands (G₂, G₃). The choice of bands can be determined by the local authority and can be made in the factory by the programming device 23.

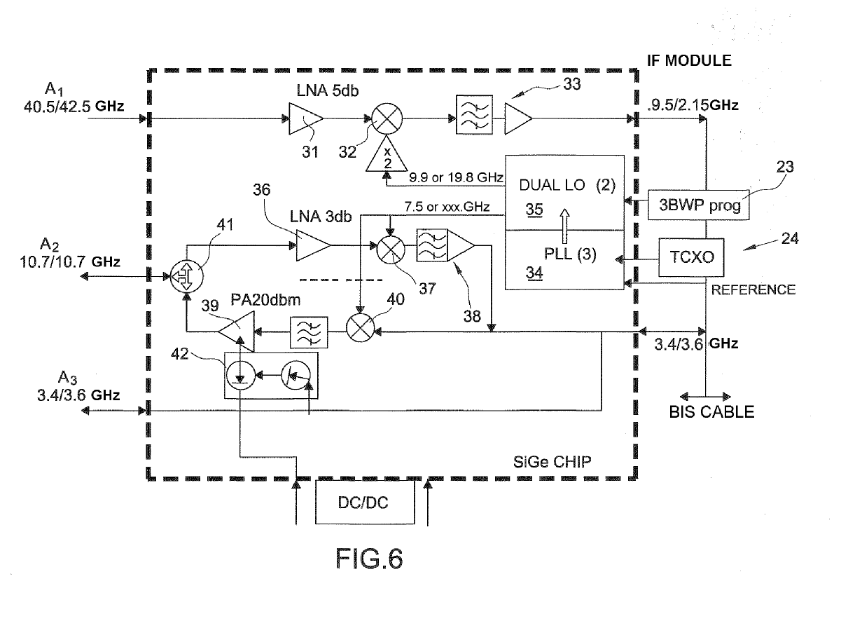

FIG. 6 represents an exemplary detailed architecture of a transceiver circuit that can be integrated on silicon-germanium, SiGe, for a subscriber.

The receiver circuit operating in the frequency range G₁ [40.55-42.5 GHz]; and the transceiver operating in the frequency range G₂ [10.7-11.3 GHz] and the frequency range G₃ [3.4-3.5 GHz] comprises, for example:
an antenna A₁, for example, of lens type made of polyurethane, suitable for operating in receive mode in the frequency range G₁. Notable among its characteristics is that it has very good secondary lobes,
a printed type “patch” antenna A₂, suitable for operating in transmit and receive modes, in the frequency range G₂ and preceded by an isolating device (not shown). The simplified reception function of this receiver makes it possible in particular to integrate the assembly on one and the same circuit, or SiGe chip,
an antenna A₃ suitable for the range G₃ and making it possible to operate directly via the cable 25 with a commercially-available integrated Wimax wireless modem, for example,
a phase-locked loop 34 and an oscillator 35,
a receiver suitable for operating in the frequency range G₁, comprising, for example, a GaAs low-noise amplifier LNA, 31, a mixer 32 operating on the second harmonic of a simple oscillator, for example, a DRO oscillator or by the synthesizer 35. The mixing output is amplified and filtered, 33, so as to output at the top of the BIS band of the cable (2.1 GHz to 900 MHz),
on the same subcircuit, a Ku band receiver, equivalent to the commercially-available satellite LNB and a transmitter. The receiver comprises an amplifier 36, a mixer 37 activated by the oscillator 35 stabilized by the phase-locked loop. The mixing output is then amplified and filtered 38. The transmitter consists of an amplifier 39 of approximately 100 mW, possibly preceded by a preamplifier (not shown) of a mixer 40 activated by the oscillator 35 stabilized by the phase-locked loop 34.

With the transmitter and the receiver operating in TDD mode, the protection subcircuit 41, 42 is used to isolate the LNB from the amplifier 36.

The MMT also comprises the following circuits:
the abovementioned protection function comprising a circulator 41 and a switch 42 of the output amplifier 39, for isolating the residual noise deriving from the amplifier in the absence of modulation signal, in other words, when the TDD or time-division duplex is in receive mode on the MMT, the absence of detection of the signal from the cable cuts the power supply to the amplifier 39 (PA20dbm).

The values of the two local oscillator frequencies obtained from the DUAL LO block 2 are chosen according to the multiplication mode of the mixers for the transpositions of the frequency ranges G₁ and G₂.

The phase-locked loop 34 (PLL3) of the oscillator 35 (DUAL LO 2) is locked on the downlink WiMax reference and stabilized in phase noise terms by the TCXO oscillator referenced 24.

The programming block 23 (3BWP prog) is adapted to allow the choice, on leaving the factory for example, of one of the three bands for the local application, the range being assigned by the regulatory authority.

The assembly is housed, for example, in a rain-tight box, the front panel receiving the two antennas and the rear panel the home input/output cable to the subscriber's TV set-top box and modem.

The antennas have patterns adapted for the bases to cover the terrain, and directional patterns with small secondary lobes for the subscribers. This provides an immunity to high-density interferences and radiofrequency protection.

The characteristic patch antenna structure makes it possible in particular to cover sectors in precise angles.

### ADVANTAGES

The terminal according to the invention has the following particular advantages. The terminal is a multiband wireless transceiver which can be used to set up very broadband wireless, or “triple play”, networks with the following performance characteristics:

| scenario | transmission | reception | band | capacities |
|---|---|---|---|---|
| Q band | | 5 db | 40.5-43.5 GHz | 1 Gbps |
| Ku band | 20 dbm | 3 db | 10.7-11.7 GHz | 300 Mbps |
| C band | 10 dbm | 3 db | 3.4-3.6 GHz | 70 Mbps |
| | | | Each band is | |
| | | | subdivided into three | |
| | | | sub-bands | |

The Q band receiver makes it possible in particular to receive at least 100 TV channels, high-definition television (HD TV), video on demand and, at the same time, IP streams from the Internet at bit rates of over 10 Mbps per user and for an overall capacity greater than 100 Mbps.

The transceiver at 10 GHz or 3.5 GHz makes it possible in particular to raise the IP streams to a bit rate of several Mbps with a total capacity of more than 50 Mbps.

The option of choosing between 10 GHz and 3.5 GHz enables the device to be adapted to the local situation and to the requirements of the regulatory authority.

The arrangement of the BIS frequency enables each of the subscribers appliances to be interfaced with each service transmitted or received by the multiband microwave terminal.

The phase noises and stability of the local oscillators LO are suited to the waveforms of the standards used (DVB in the range G₁ and WIMAX in the ranges G₂ or G₃).

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A multiband microwave transceiver device, MMT, comprising:
a circuit for coupling with an antenna A₁, operating in a frequency range G₁ corresponding to multimedia services, to rich media services (synchronized image and Internet), and
a circuit for coupling with an antenna A₂, suitable for operating in a frequency range G₂ corresponding to Internet and voice services,
a circuit for coupling with an antenna A₃, suitable for operating in a range G₃ and allowing direct operation with a commercially-available WIMAX modem in this band via the BIS frequency, and
frequency synthesizers suitable for the conversions and amplification and conversion circuits in both directions:
down-conversion from 40 GHz to the BIS frequency,
down-conversion from 10 GHz to 3.5 GHz,
up-conversion from 3.5 GHz to 10 GHz.

2. The device as claimed in claim 1, comprising an SiGe component, suitable for performing the reception and transmission, frequency transposition and synthesis functions, an intermediate frequency module suitable for performing the functions of filtering and adaptation to transmission over the BIS cable and for programming the frequency bands defined by the regulatory authority.

3. The device as claimed in claim 2, wherein the SiGe component comprises:
a receiver suitable for operating in the frequency range G₁ comprising a low-noise amplifier, a mixer suitable for operating on the second harmonic of a simple oscillator, an amplifier and filter function for output at the top of the BIS band of the cable (2.1 GHz to 900 MHz),
a Ku band receiver consisting of an amplifier, a mixer activated by an oscillator stabilized by phase-locked loop and a transmitter consisting having of an amplifier and a mixer activated by the oscillator stabilized by the phase-locked loop,
a protection circuit comprising a circulator and switch for the output amplifier.

4. The device as claimed in claim 1, wherein the coupling circuits are suitable for a lens-type antenna A₁.

5. The device as claimed in claim 1, wherein the coupling circuits are suitable for a patch-type antenna A₂.

6. The device as claimed in claim 1, wherein the coupling circuits are suitable for a bi-band Cassegrain-type antenna A₃.

7. A multiband microwave transceiver device comprising three antennas A₁, A₂ and A₃ and a radio card, comprising at least one transceiver device MMT as claimed in claim 1.
